(19) United States
(12) Patent Application Publication
(10) Pub. No.: US 2010/0211758 A1
(43) Pub. Date: Aug. 19, 2010

(54) MICROPROCESSOR AND MEMORY-ACCESS CONTROL METHOD

(75) Inventors: Masato Sumiyoshi, Tokyo (JP); Takashi Miyamori, Kanagawa (JP); Shunichi Ishiwata, Chiba (JP); Katsuyuki Kimura, Kanagawa (JP); Takahisa Wada, Kanagawa (JP); Keiri Nakanishi, Kanagawa (JP); Yasuki Tanabe, Tokyo (JP); Ryuji Hada, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Minato-ku, Tokyo (JP)

(21) Appl. No.: 12/648,769

(22) Filed: Dec. 29, 2009

(30) Foreign Application Priority Data
Feb. 16, 2009 (JP) 2009-032534

(51) Int. Cl. G06F 9/312; G06F 9/445; G06F 9/46; G06F 12/00; G06F 9/34

(52) U.S. Cl. 712/22; 712/205; 712/42; 718/102; 711/154; 712/E09.033; 712/248; 711/E12.001; 712/E09.038

(57) ABSTRACT

A microprocessor that can perform sequential processing in data array unit includes: a load store unit that loads, when a fetched instruction is a load instruction for data, a data sequence including designated data from a data memory in memory width unit and specifies, based on an analysis result of the instruction, data scheduled to be designated in a load instruction in future; and a data temporary storage unit that stores use-scheduled data as the data specified by the load store unit.

### CROSS-REFERENCE TO RELATED APPLICATIONS

This application is based upon and claims the benefit of priority from the prior Japanese Patent Application No. 2009-032534, filed on Feb. 16, 2009; the entire contents of which are incorporated herein by reference.

### BACKGROUND OF THE INVENTION

1. Field of the Invention

The present invention relates to a microprocessor and a memory-access control method.

2. Description of the Related Art

A microprocessor includes a memory (an instruction memory) in which instructions are stored, an instruction fetch unit that fetches (reads out) an instruction to be executed from the instruction memory, a processing unit that accesses a memory in which data is stored and performs arithmetic operation according to the instruction read out by the instruction fetch unit, and a data memory. The microprocessor can simultaneously perform processing for a plurality of data according to one instruction.

In some instruction executed by the processing unit, the width (the number of bits) of data used in processing indicated by the instruction (data loaded from the data memory) and the memory width of the data memory are not aligned. Therefore, a microprocessor in the past adopts, to prevent an increase in latency and a fall in throughput in executing such an instruction, a configuration in which a memory instance is divided to increase the number of banks. A method of simultaneously accessing all banks in which data designated by an instruction is present is used in the microprocessor.

However, in the method, an area overhead also increases according to the increase in the number of banks.

Power consumption also increases according to the increase in the number of banks simultaneously accessed.

Japanese Patent Application Laid-Open No. 2004-38544 discloses, as an example of the microprocessor in the past, an image processing apparatus in which a fall in performance is suppressed. Japanese Patent Application Laid-Open No. 2002-358288 discloses, as another example of the microprocessor in the past, a semiconductor integrated circuit that efficiently performs single instruction multiple data (SIMD) operation. However, the technologies disclosed in these patent documents do not take into account the problems due to the increase in the number of banks of the data memory.

### BRIEF SUMMARY OF THE INVENTION

A microprocessor according to an embodiment of the present invention comprises: a load store unit that loads, when a fetched instruction is a load instruction for data, a data sequence including designated data from a data memory in memory width unit and specifies, based on an analysis result of the instruction, data scheduled to be designated in a load instruction in future in the loaded data sequence; and a data temporary storage unit that stores use-scheduled data as the data specified by the load store unit.

A memory-access control method according to an embodiment of the present invention comprises: loading, when a load instruction for data is fetched, a data sequence including designated data from the data memory in memory width unit; specifying, based on an analysis result of the load instruction, data scheduled to be designated in a load instruction in future in the loaded data sequence; and writing the data specified in the specifying in a data temporary storage unit as use-scheduled data.

### BRIEF DESCRIPTION OF THE DRAWINGS

FIG. 1 is a diagram of an operation example in which the width of data (processing target data) used during execution of an instruction and the memory width of a data memory are aligned;

FIG. 2 is a diagram of an operation example in which the width of data (processing target data) used during execution of an instruction and the memory width of the data memory are not aligned;

FIG. 3 is a diagram of image data including 3×3 pixels;

FIG. 4 is a diagram of a configuration example of a microprocessor according to a first embodiment of the present invention;

FIG. 5 is a diagram of a concept of memory access operation performed when data width is not aligned with memory width;

FIG. 6 is a diagram of an internal configuration example of a data temporary storage unit;

FIG. 7 is a diagram of the overall operation of the microprocessor;

FIG. 8 is a diagram of an example of a relation of operation for banks of a memory; and

FIG. 9 is a diagram of a configuration example of an address generating unit included in a microprocessor according to a second embodiment of the present invention.

### DETAILED DESCRIPTION OF THE INVENTION

Exemplary embodiments of a microprocessor and a memory-access control method. according to the present invention will be explained below in detail with reference to the accompanying drawings. The present invention is not limited to the following embodiments.

First, types of instructions executed by processors according to the embodiments and an example of operation performed when a processor in the past executes the same instructions are explained.

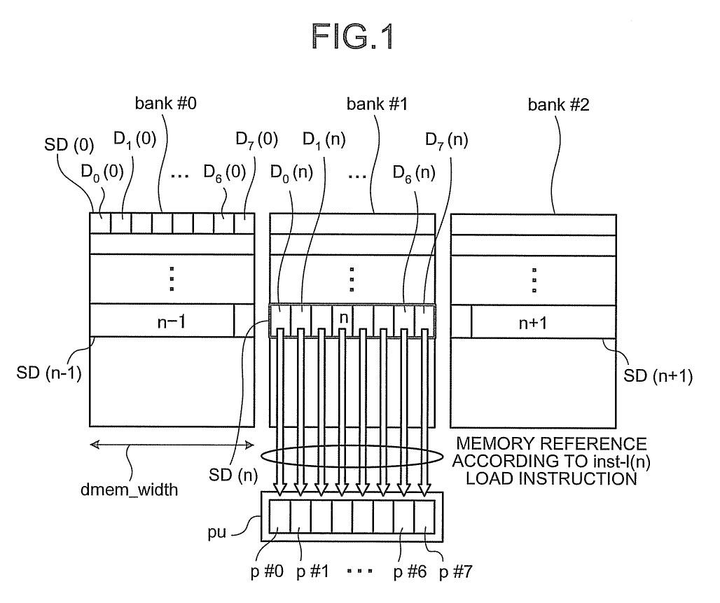

FIG. 1 is a diagram of an example of operation executed by a processor when the width of data (processing target data) used during execution of an instruction and the memory width of a data memory are aligned. In the operation example shown in FIG. 1, image data as processing targets are arranged in raster scan order (D₀(0), D₁(0), D₂(0), . . . ) with respect to a data memory having width dmem_width. More specifically, this is an operation example of SIMD operation in which a processor (pu) allocates a plurality of arithmetic elements (p#0, p#1, . . . , and p#7) to elements (D₀(k), D₁(k), D₂(k), D₇(k), where k=0, 1, 2, . . . , n−1, n, n+1,. . . ) of data having the width dmem width and executes instructions in parallel to thereby proceed with processing in order of SD(0), SD(1), . . . , and SD(n) in dmem width unit. Execution of an instruction inst-1 on SD(n) is represented as inst-1(n).

In the example shown in FIG. 1, in arithmetic operation for data (D₀(n), D₁(n), D₂(n), D₇(n)) of SD(n), memory reference by the instruction inst-1(n) is aligned with the memory width dmem width. In such a case, the data (D₀(n) D₁(n), D₂(n), D₇(n)) supplied to the arithmetic elements (p#0 to p#7) can be loaded in one memory access.

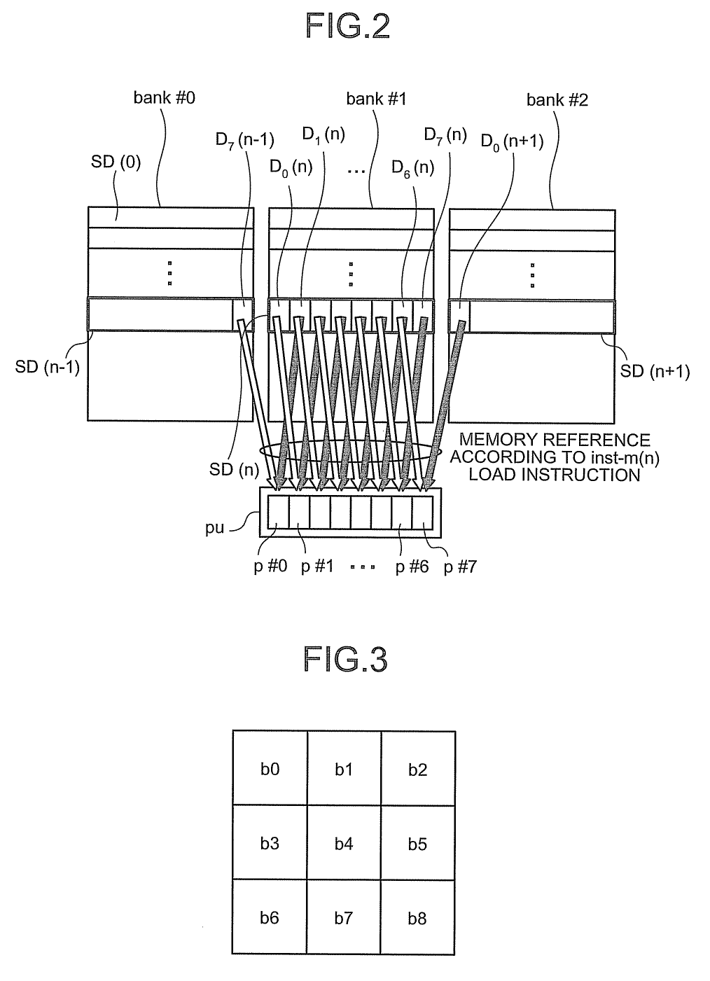

FIG. 2 is a diagram of an example of operation performed by the processor when the width of data used during execution of an instruction and the memory width of the data memory are not aligned unlike the example shown in FIG. 1. This is operation effective when the arithmetic elements can increase speed of arithmetic operation in, for example, filter processing for image data including 3×3 pixels shown in FIG. 3 by simultaneously reading out two data including certain pixel data (data in a certain pixel position) and pixel data immediately preceding or immediately following the pixel data (e.g., two pixel data present in positions b0 and b2 or two pixel data present in positions b3 and b5).

In the operation shown in FIG. 2, the arithmetic element p#0 refers to D₇(n−1) and D₁(n) and the arithmetic element p#1 refers to D₀(n) and D₂(n). Similarly, the arithmetic element p#i refers to Dᵢ₋₁(n) and Dᵢ₋₁(n) (i=2, 3, 4, 5, and 6). The arithmetic element p#7 refers to D₆(n) and D₀(n+1). Specifically, the arithmetic elements p#0 and p#7 need to load two data from an area across a boundary of the memory width dmem_width. In realizing such operation while preventing a fall in processing speed, the processor in the past adopts a configuration that can simultaneously refer to three banks. However, when such a plurality of (three in this example) banks can be simultaneously referred to, as explained above, an increase in an area overhead and an increase in power consumption are caused. Therefore, it is advantageous in terms of the area overhead and the power consumption to minimize the number of banks simultaneously referred to. As a result, a reduction in cost and improvement of performance can be realized.

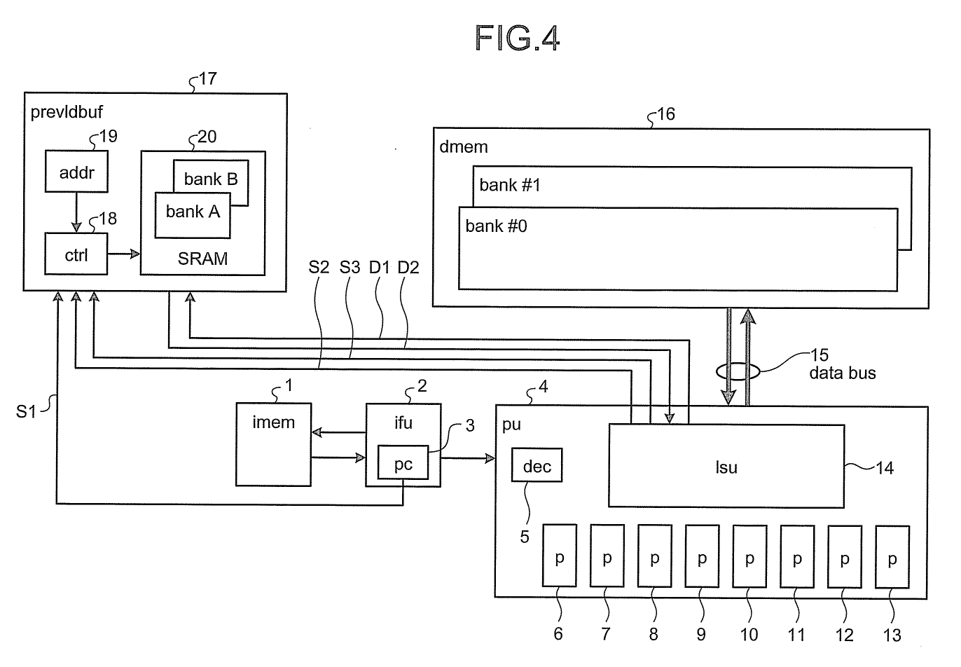

A processor according to a first embodiment of the present invention is explained below. In examples explained in the first embodiment and a second embodiment, processors are SIMD processors. However, the configuration of the processors does not have to be the SIMD type. FIG. 4 is a diagram of a configuration example of the processor according to the first embodiment. As shown in the figure, the processor according to this embodiment includes an instruction memory (imem) 1, an instruction fetch unit (ifu) 2, a processing unit (pu) 4, a data memory (dmem) 16, and a data temporary storage unit (prevldbuf) 17.

The instruction memory 1 is a memory that stores an instruction for controlling the processing unit 4. The instruction fetch unit 2 includes a program counter (pc) 3 that outputs a value indicating a number of an instruction to be executed. The instruction fetch unit 2 extracts an instruction to be executed from the instruction memory 1 according to an output value of the program counter 3.

The processing unit 4 includes an instruction decoder (dec) 5, a plurality of arithmetic elements (p) 6 to 13, and a load store unit (lsu) 14. The processing unit 4 executes various kinds of processing according to the instruction extracted from the instruction memory 1 by the instruction fetch unit 2. Specifically, the processing unit 4 receives the instruction extracted by the instruction fetch unit 2. The instruction decoder 5 decodes the instruction. The load store unit 14 exchanges data with the data memory 16 according to the decoded instruction. The arithmetic elements 6 to 13 execute various kinds of arithmetic operation. The load store unit 14 reads out (loads) data from and writes (stores) data in the data memory 16 in memory width unit. When loaded data includes data scheduled to be designated in the next load instruction as well, the load store unit 14 stores the data in the data temporary storage unit 17. In addition, when data used in processing to be executed by the arithmetic elements next (use-scheduled data) is stored in the data temporary storage unit 17, the load store unit 14 acquires the use-scheduled data.

Formats of various instructions used in the control by the processor according to this embodiment are not specifically limited. However, it is assumed that the load instruction received from the instruction fetch unit 2 includes information concerning whether the data loaded from the data memory 16 is scheduled to be designated in the next load instruction as well.

In repeated execution (n=0, 1, 2, . . . ) of an instruction sequence (m=0, 1, 2, . . . ), when execution inst-m(n) of a certain load instruction m in the repetition n of the instruction sequence is the present load instruction, execution inst-m(n+1) of the load instruction m in repetition n+1 of the instruction sequence is the next load instruction.

The data memory 16 includes two bank areas (a bank #0 and a bank #1). The processing unit 4 can simultaneously refer to the two banks.

The data temporary storage unit 17 includes a control circuit (ctrl) 18, an address generating unit (addr) 19, and a memory (static random access memory (SRAM)) 20 including two banks (a bank A and a bank B). When the data temporary storage unit 17 receives data (D1) scheduled to be used in future from the processing unit 4, the data temporary storage unit 17 stores the data (D1). When the data temporary storage unit 17 receives a readout request for the stored data, the data temporary storage unit 17 outputs the data.

The control circuit (a control unit) 18 reads out data from and writes data in the memory 20 according to control signals S2 and S3 input from the load store unit 14. The address generating unit 19 generates, based on an output value (Si) of the program counter 3, an address for accessing the memory 20. The memory 20 stores, in one of the bank areas, data received from the processing unit 4.

The processor according to this embodiment having the configuration explained above has a function of proceeding with processing in data array unit (equivalent to SD(0), SD(1), . . . , SD(n) shown in FIGS. 1 and 2) in raster scan order. When the processor proceeds with the processing in data array unit in raster scan order, data processed in inst-m(n) (execution for the nth time of a certain instruction m) is adjacent to a data array processed in inst-m(n−1). If data width designated by a load instruction and the memory width of a data memory are aligned, when a load request to SD(n) is issued in inst-m(n), SD(n−1) is referred to in inst-m(n−1) and SD(n+1) is referred to in inst-m(n+1).

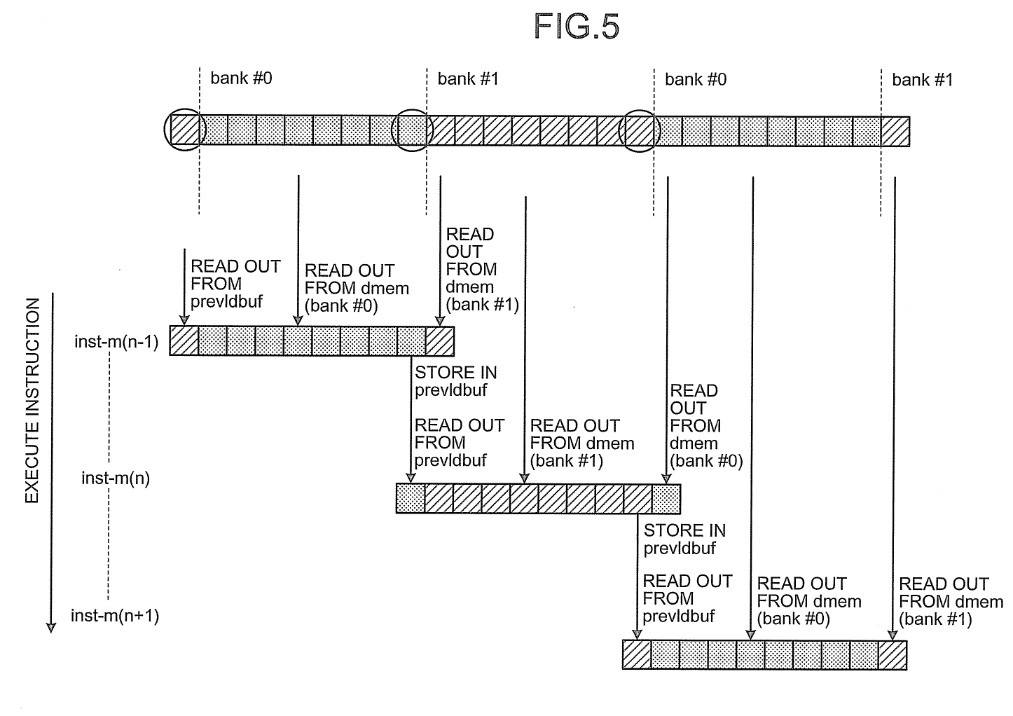

Therefore, in the processor according to this embodiment, when data referred to in inst-m(n+1) as well is present in data read out in inst-m(n), i.e., when the data width designated by the load instruction and the memory width of the data memory are not aligned, the data referred to in inst-m(n+1) as well is stored in the data temporary storage unit 17. For example, in the case of the example shown in FIG. 2, among data loaded in inst-m(n), data D₇(n) referred to in common in inst-m(n+1) and, for inst-m(n+1), deviating from memory alignment is stored in the data temporary storage unit 17. In inst-m(n+1), D₀(n+1) to D₇(n+1) and D₀(n+2) are read out from the data memory 16. D₇(n) stored during execution of the load instruction in inst-m(n) is extracted from the data temporary storage unit 17 and combined with the data (D₀(n+1) to D₇(n+1) and D₀(n+2)) read out from the data memory 16 to obtain final data (processing target data) used in arithmetic processing. A concept of this operation (access operation not aligned with the memory width) is shown in FIG. 5. By executing such operation, it is possible to minimize the number of banks of a data memory simultaneously referred to in an access not aligned with the memory width.

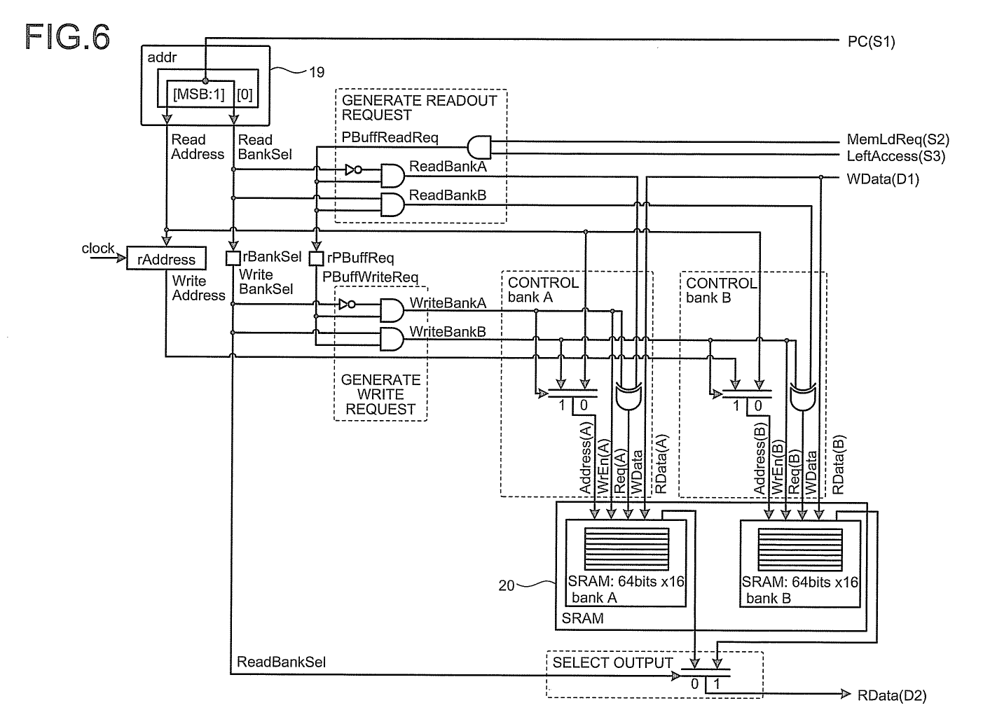

FIG. 6 is a diagram of an internal configuration example of the data temporary storage unit 17 used in the access operation not aligned with the memory width. In FIG. 6, components same as those shown in FIG. 4 are denoted by the same reference numerals and signs. In FIG. 6, a section excluding the address generating unit 19 and the memory 20 is equivalent to the control circuit 18.

An upper limit of the number of data stored in the data temporary storage unit 17 depends on deviation width from the memory alignment allowed by the processor. Specifically, the banks of the memory (SRAM) 20 of the data temporary storage unit 17 can be limited to bit width enough for storing the number of data equivalent to the deviation width. For example, in the case of the processor that controls only accesses shown in FIG. 2, because lying-off width (deviation width) from the memory alignment is 1, the data width of the banks of the memory 20 only has to be width equivalent to one data. As a specific example, when one data is 16 bits, the data width of the banks only has to be 16 bits. This makes it possible to hold down a memory capacity. In the example shown in FIG. 6, the data width is set to 64 bits.

It is possible to reduce the number of words of the banks (the banks A and B) of the memory 20 by limiting the number of words to the number of instructions that can refer to the data of SD(n−1). For example, when maximum deviation width from the memory alignment that can be designated by the load instruction is 16 bits (16-bit data×1) and an upper limit of the number of issuable load instructions deviating from the memory alignment is thirty-two, the banks A and B only have to have a 16 bit×16 word configuration (a total number of words of the banks A and B is thirty-two). This makes it possible to hold down a memory capacity.

The data temporary storage unit 17 having the configuration explained above stores, according to PC (Si) as an output signal (a program counter value) from the program counter 3 of the instruction fetch unit 2, MemLdReq (S2) as an output signal from the load store unit 14 of the processing unit 4, and LeftAccess (S3), data received from the load store unit 14 through WData (D1) in the memory 20. The data temporary storage unit 17 outputs the data stored in the memory 20 to the load store unit 14 through RData (D2). The MemLdReq signal (S2) is a signal for requesting output (load) of the data stored by the data temporary storage unit 17. The LeftAccess signal (S3) is a signal indicating that an access deviates from the memory alignment. As explained in detail later, the data temporary storage unit 17 simultaneously performs operation for writing data in one bank of the memory 20 and operation for reading out data from the other bank to thereby prevent a fall in processing speed of the entire processor.

Detailed operation of the data temporary storage unit 17 is explained below together with operations of other sections related thereto in the processor.

When an instruction extracted from the instruction memory 1 by the instruction fetch unit 2 is a load instruction for data and indicates a memory access deviating from the memory alignment, the load store unit 14 asserts (activates) the MemLdReq signal S2 and the LeftAccess signal S3 for access to the data temporary storage unit 17.

When the data temporary storage unit 17 detects that the MemLdReq signal S2 is asserted, the data temporary storage unit 17 performs readout operation from the memory 20. This cycle is referred to as LO below.

Specifically, first, the control circuit 18 calculates AND of the MemLdReq signal S2 and the LeftAccess signal S3 to generate a signal (PBuffReadReq) indicating the readout operation from the memory 20. To perform write operation explained below continuously from the readout operation, the control circuit 18 writes PBuffReadReq in a register as rPBuffReq.

The address generating unit 19 generates, based on an input program counter value (hereinafter, “PC value”), an address signal (ReadAddress) indicating an access destination of the memory 20 and a bank selection signal (ReadBankSel). More specifically, the address generating unit 19 outputs a least significant bit of the PC value as the bank selection signal and outputs the remaining bits as the address signal. Consequently, because banks to be used are reversed according to load instructions having continuous PC values, it is possible to continuously perform update operation explained later. ReadBankSel and ReadAddress are written in the register as rBankSel and rAddress to be referred to in the next cycle (L1).

When PBuffReadReq is asserted, the control circuit 18 selects a bank according to ReadBankSel. Specifically, when ReadBankSel is 0, the control circuit 18 enables a bank-A readout request signal (ReadBankA) and, when

ReadBankSel is 1, the control circuit 18 enables a bank-B readout request signal (ReadBankB).

In the control circuit 18, a readout request (ReadBankA) and a readout address (ReadAddress) are input to a bank-A control circuit. The bank-A control circuit enables a bank-A access request (Req(A)) unless the input readout request (ReadBankA) and a write request explained later conflict with each other. Similarly, a readout request (ReadBankB) and a readout address (ReadAddress) are input to the bank-B control circuit. The bank-B control circuit enables a bank-B access request (Req(B)) unless the input readout request (ReadBankB) and a write request explained later conflict with each other.

The control circuit 18 selects, according to rBankSel, one of data output from the bank A and the bank B of the memory 20 and outputs the selected data to the load store unit 14 as the readout data RData (D2) of the data temporary storage unit 17.

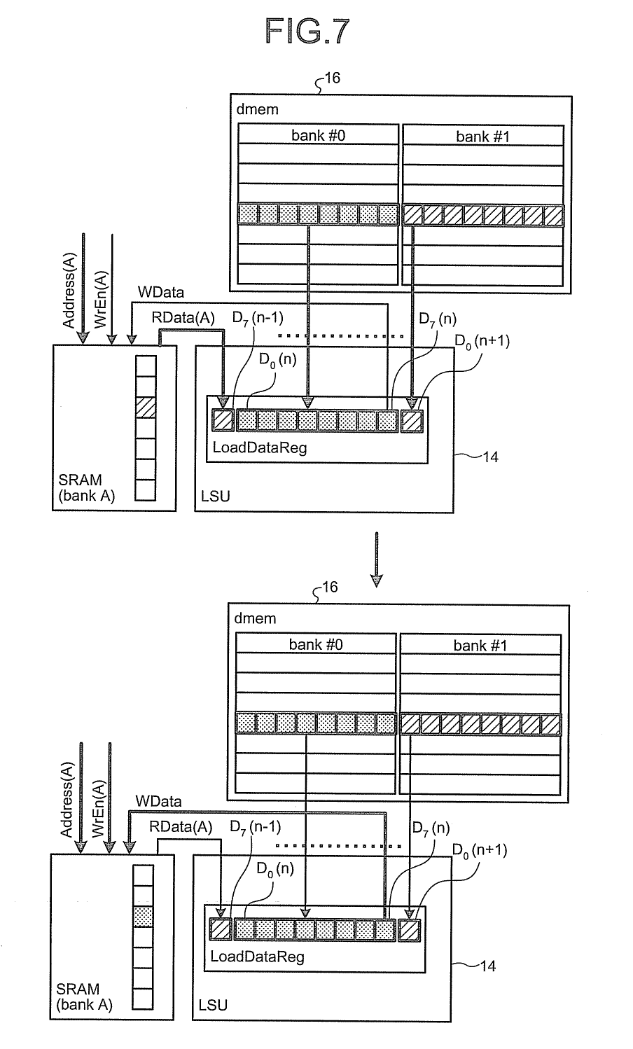

The load store unit 14 receives the data output from the data temporary storage unit 17. As shown in the upper section of FIG. 7, the load store unit 14 combines the RData (D2) output from the data temporary storage unit 17 and the data read out from the data memory 16 to generate data in arithmetic processing unit (length) in the arithmetic elements. The load store unit 14 passes the generated data to a predetermined arithmetic element. The arithmetic element that receives the data executes arithmetic operation according to an instruction decoded by the instruction decoder 5.

FIG. 7 is a diagram of the overall operation of the processor. In the upper section of the figure, operation for reading out data from the data memory 16 and the memory 20 (SRAM) executed in the cycle L0 is shown. In the lower section, operation executed in the next cycle L1 is shown. Specifically, in the operation of the data temporary storage unit 17 in the cycle L1 following the cycle L0, the data temporary storage unit 17 updates data stored in an area of the memory 20 accessed (referred to) in the operation in the cycle L0.

Specifically, a bank and an address indicating the area to be updated are the same as those during the readout. Therefore, in the update operation, the control circuit 18 reads out rBankSel and rAddress from the resisters in which values used in the cycle LO from are stored and sets the values as a bank selection signal WriteBankSel and an address WriteAddress for update.

The control circuit 18 reads out a value from the register that stores rPBuffReq representing that the readout operation is performed in the cycle L0 and sets the value as a write request signal PBuffWriteReq. When PBuffWriteReq is asserted, the control circuit 18 selects a bank according to WriteBankSel. Specifically, when WriteBankSel is 0, the control circuit 18 enables a bank-A write request signal (WriteBankA) and, when WriteBankSel is 1, the control circuit 18 enables a bank-B write request signal (WriteBankB).

In the control circuit 18, the write request (WriteBankA) and the write address (WriteAddress) are input to the bank-A control circuit. The bank-A control circuit enables the bank-A access request (Req(A)) unless the input writ request (WriteBankA) and the readout request (ReadBankA) conflict with each other. Similarly, the write request (WriteBankB) and the write address (WriteAddress) are input to the bank-B control circuit. The bank-B control circuit enables the bank-B access request (Req(B)) unless the input write request (WriteBankB) and the readout request (ReadBankB) conflict with each other.

The control circuit 18 gives the memory 20 the access request (Req(A) or Req(B)) and write data WData (D2) received from the load store unit 14 to update the data. WData (D2) is obtained by selecting data of a section referred to during execution of the next instruction (inst-m(n+1)) (in the operation example shown in FIG. 7, equivalent to the right end data D₇(n)) among the D(n) data read out from the data memory 16 by the load store unit 14.

In the data temporary storage unit 17 shown in FIG. 6, the bank control circuits (the bank-A control circuit and the bank-B control circuit) include E×OR circuits to prevent the access requests (Req(A) and Req(B)) from being enabled when the input write requests (WriteBankA and WriteBankB) and the readout requests (ReadBankA and ReadBankB) conflict with each other. However, it is also possible to replace the E×OR circuits with OR circuits and control input signals from the load store unit 14 to the data temporary storage unit 17 to thereby realize operation for preventing the write requests and the readout requests from conflicting with each other.

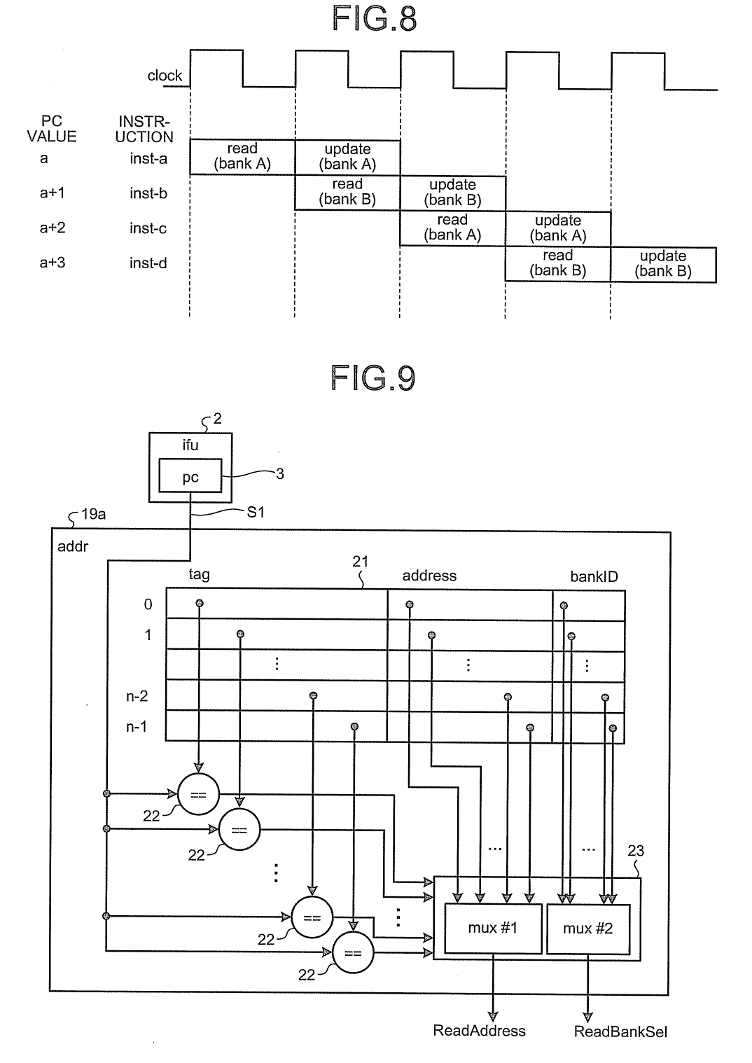

In the above explanation, the data readout operation and the data write operation for one bank of the memory 20 are explained. However, the processor applies opposite operation to the other bank in parallel to the data readout operation or the data write operation (when the data readout operation is applied to one bank, the data write operation is applied to the other bank) to thereby prevent a fall in processing speed of the processor as a whole (see FIG. 8). FIG. 8 is a diagram of a relation of operation for the banks of the memory 20. The data write operation is performed in a cycle described as “update”.

As explained above, in executing a load instruction in which the width of reference data (processing target data) and the memory width of the data memory are not aligned, when data referred to in a load instruction to be executed next time (data scheduled to be designated in the load instruction to be executed next time) is included in a data sequence to be loaded, the processor according to this embodiment stores the data in the data temporary storage unit. The processor reads out the stored data from the data temporary storage unit during execution of the next load instruction. The processor reads out, from the data memory, the remaining processing target data other than the data read out from the data temporary storage unit (data not stored in the data temporary storage unit among the data designated by the load instruction). The processor executes, in parallel, processing for reading out data from one bank in the memory and processing for writing data in the other bank. This makes it possible to reduce, compared with the past, the number of banks in the data memory provided to prevent an increase in latency and a fall in throughput in executing an instruction in which the width of reference data and the memory width are not aligned. As a result, it is possible to realize a processor that holds down an area overhead and power consumption while maintaining processing performance.

In the technology disclosed in Japanese Patent Application Laid-Open No. 2004-38544, in some case, data transfer time from an input line buffer to an SIMD processor increases. Specifically, when data transfer speed is A bit/cycle and the bit width (the number of bits) of data used in SIMD processing is B, transfer time is B/A cycles. For example, when A is 16 and B is 128, the transfer time is 8 cycles. Therefore, waiting time from the storage of data in the input line buffer until the start of SIMD operation occurs. In the technology disclosed in Japanese Patent Application Laid-Open No. 2002-358288, the use of a data buffer of a dual port is a premise. However, in the SIMD processor according to this embodiment, the waiting time until the start of arithmetic operation (waiting time equal to or longer than two cycles) does not occur and the use of a data buffer of a dual port is not a premise.

In the processor according to the first embodiment, the address generating unit 19 of the data temporary storage unit 17 uses a least significant bit of a program counter value (PC value) as a bank select signal and uses the remaining bits as an address signal (see FIG. 6). On the other hand, a processor according to a second embodiment of the present invention generates a bank select signal and an address signal based on a PC value and a lookup table (LUT). The overall configuration of the processor is the same as that of the processor according to the first embodiment (see FIG. 4).

FIG. 9 is a diagram of a configuration example of an address generating unit of a data temporary storage unit included in the processor according to the second embodiment. The configuration of the data temporary storage unit is the same as that of the data temporary storage unit 17 according to the first embodiment except an address generating unit 19a (see FIG. 6).

As shown in FIG. 9, the address generating unit 19a includes an LUT 21, a plurality of comparators 22, and a signal selecting unit 23. The LUT 21 includes a plurality of (n in FIG. 9) record areas. Each of the records includes fields for a tag, an address, and bank identification information (bank ID). The number of the comparators 22 is the same as the number of records in the LUT 21. The comparators 22 output results of comparison of tags in the records associated with the comparators 22 and an input PC value. The comparators 22 input the comparison results to the signal selecting unit 23. The signal selecting unit 23 selects any one of the records based on the input comparison results and outputs an address and bank identification information registered in the record. The signal selecting unit 23 includes, as components for realizing this operation, a first multiplexer (mux#1) and a second multiplexer (mux#2). The first multiplexer (mux#1) selects, based on the comparison results in the comparators 22, one of addresses stored in the records of the LUT 21. The second multiplexer (mux#2) selects, based on the comparison results in the comparators 22, one of pieces of bank identification information stored in the records of the LUT 21.

When the address generating unit 19a explained above is adopted, it is possible to realize a processor that can obtain effects same as those of the processor according to the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A microprocessor that can perform sequential processing in data array unit, the microprocessor comprising:
a load store unit that loads, when a fetched instruction is a load instruction for data, a data sequence including designated data from a data memory in memory width unit and specifies, based on an analysis result of the instruction, data scheduled to be designated in a load instruction in future in the loaded data sequence; and
a data temporary storage unit that stores use-scheduled data as the data specified by the load store unit.

2. The microprocessor according to claim 1, wherein the load store unit acquires, when data is further loaded, if data specified as use-scheduled data during execution of a last load instruction is stored by the data temporary storage unit, the stored use-scheduled data, combines the use-scheduled data with data designated by a present load instruction among the loaded data, and generates final processing target data corresponding to the present load instruction.

3. The microprocessor according to claim 1, wherein the data temporary storage unit includes:
a memory that stores the use-scheduled data;
an address generating unit that determines, based on a value of a program counter, an access target area in the memory; and
a control unit that accesses the access target area determined by the address generating unit and performs, according to an instruction from the load store unit, processing for writing the use-scheduled data received from the load store unit or processing for reading out the written use-scheduled data and outputting the use-scheduled data to the load store unit.

4. The microprocessor according to claim 3, wherein
the memory is a memory including two banks, and
the address generating unit determines the access target area such that the use-scheduled data received from the load store unit are alternately directed to the banks in the memory.

5. The microprocessor according to claim 3, wherein
the memory is a memory including two banks,
the address generating unit generates, based on a value of the program counter, a bank select signal designating one bank in the memory and an address signal indicating an access target area in the designated bank, and
the control unit executes in parallel, according to the bank select signal and the address signal generated by the address generating unit, processing for writing the use-scheduled data in one bank in the memory and processing for reading out the use-scheduled data from the other bank in the memory.

6. The microprocessor according to claim 5, wherein a least significant bit of the program counter is used as the bank select signal.

7. The microprocessor according to claim 6, wherein remaining bits excluding the least significant bit of the program counter are used as the address signal.

8. The microprocessor according to claim 3, wherein the control unit simultaneously executes processing for writing the use-scheduled data in an access target area determined this time by the address generating unit and processing for reading out the use-scheduled data from an access target area determined last time by the address generating unit.

9. The microprocessor according to claim 3, wherein the address generating unit determines, using a lookup table, the access target area based on a result of comparison of information in records of the lookup table and a program counter value.

10. The microprocessor according to claim 9, wherein
the memory is a memory including two banks, and
the lookup table is configured such that the use-scheduled data received from the load store unit are alternately directed to the banks in the memory.

11. The microprocessor according to claim 4, wherein data width of the banks is set to a size corresponding to deviation width from memory alignment allowed by the microprocessor.

12. The microprocessor according to claim 4, wherein a number of words of the banks is set to a number corresponding to an upper limit of a number of instructions issuable by the microprocessor.

13. The microprocessor according to claim 1, wherein the load instruction includes information concerning data scheduled to be designated by a load instruction in future.

14. The microprocessor according to claim 1, wherein the microprocessor can execute single instruction multiple data (SIMD) operation.

15. A memory-access control method performed by a microprocessor, which can perform sequential processing in data array unit, in reading out data stored in a data memory, the memory-access control method comprising:
loading, when a load instruction for data is fetched, a data sequence including designated data from the data memory in memory width unit;
specifying, based on an analysis result of the load instruction, data scheduled to be designated in a load instruction in future in the loaded data sequence; and
writing the data specified in the specifying in a data temporary storage unit as use-scheduled data.

16. The memory-access control method according to claim 15, further comprising checking, when data is loaded, data specified as use-scheduled data during execution of a last load instruction is stored in the data temporary storage unit and, when the data is stored, reading out the stored data, combining the data with data designated by a present load instruction among the loaded data, and generating final processing target data corresponding to the present load instruction.

17. The memory-access control method according to claim 15, wherein, the writing the specified data as the use-scheduled data includes determining, based on a value of a program counter, an access target area in the data temporary storage unit and writing the use-scheduled data in the determined access target area.

18. The memory-access control method according to claim 15, wherein
the data temporary storage unit is a memory including two banks, and
the writing the specified data as the use-scheduled data includes selecting, based on a least significant bit of a program counter, one of the banks of the data temporary storage unit and writing the use-scheduled data in an area in the selected bank indicated by remaining bits excluding the least significant bit of the program counter.

19. The memory-access control method according to claim 15, wherein the writing the specified data as the use-scheduled data includes determining, based on a lookup table prepared in advance and a program counter value, an access target area in the data temporary storage unit and writing the use-scheduled data in the determined access target area.

20. The memory-access control method according to claim 19, wherein
the data temporary storage unit is a memory including two banks, and
the lookup table is configured such that the use-scheduled data are alternately directed to the banks in the data temporary storage unit in the writing the specified data as the use-scheduled data.
